(19) United States
(12) Patent Application Publication
(10) Pub. No.: US 2006/0129471 A1
(43) Pub. Date: Jun. 15, 2006

(54) Methods and systems for managing financial accounts

(76) Inventors: Susan R. Moon, Manhasset, NY (US); B. George Ballman JR., Potomac, MD (US); Evan G. Minskoff, New York, NY (US); Alice C. Yu, Brooklyn, NY (US); Kevin K. Hung, Forest Hills, NY (US)

Correspondence Address: KILPATRICK STOCKTON LLP, 607 14TH STREET, N.W., WASHINGTON, DC, 20005, US

(21) Appl. No.: 11/186,278

(22) Filed: Jul. 21, 2005

Related U.S. Application Data
(60) Provisional application No. 60/590,165, filed on Jul. 21, 2004.

(51) Int. Cl. G06Q 40/00

(52) U.S. Cl. 705/35

(57) ABSTRACT

Computer-implemented methods and systems for managing a special-purpose financial account involve establishing the account by a financial institution for a consumer relating to at least one consumer-designated future purchase for a pre-determined purchase price. Thereafter, contributions to a principal balance of the account are received and interest is accrued on the principal balance by the financial institution until the principal balance and accrued interest reaches a consumer-designated target amount, at which time, the principal balance and accrued interest are disposed of according to pre-defined parameters that can involve forfeiture of the accrued interest, depending on the consumer's actions.

### PRIORITY APPLICATION

This application claims priority to co-pending U.S. Provisional Application No. 60/590,165, filed Jul. 21, 2004, entitled “METHODS AND SYSTEMS FOR MANAGING FINANCIAL ACCOUNTS”, which is incorporated herein by this reference.

### FIELD OF THE INVENTION

The present invention relates generally to the field of financial accounts, and more particularly to methods and systems for managing financial accounts earmarked for a particular purpose.

### BACKGROUND OF THE INVENTION

Many consumers typically find it difficult to save for large item purchases and often require credit in order to make such purchases. Accordingly, there is a present need for a type of financial account that provides consumers with the capability to save and earmark funds for future use, that enables consumers to easily contribute into the account with additional incentives provided by the financial institution, and that allows consumers to manage their funds for future purchases.

### SUMMARY OF THE INVENTION

It is a feature and advantage of the present invention to provide a method and system for managing financial accounts that significantly motivates consumers to save money, for example, to purchase a particular item that they wish to acquire but cannot presently afford.

It is a further feature and advantage of the present invention to provide a method and system for managing financial accounts that enables consumers to earn generous incentives, whether through interest, rewards, or other incentives provided by the financial institution or merchant, and that in connection with which the merchant may provide additional incentives to guarantee future purchases in various forms, for example in dollars, points, or even percentage discounts.

It is a further feature and advantage of the present invention to provide a method and system that allows consumers, for example, to save for either a single item purchase, a basket of goods, items in particular categories, or the like, for which funds contributed and earned will go towards the purchase.

It is an additional feature and advantage of the present invention to allow consumers multiple methods of contributing towards the savings account for which funding sources may include money from linked checking and savings accounts, dollar amounts and interest from the financial institution or merchant, all currency gift certificates, dollar matching contributions, etc.

It is a further feature and advantage of the present invention to enable targeted offers to consumers who may have inclinations towards saving for future purchases utilizing, for example, proprietary analytics in conjunction with offers to provide the right offers at the right time to consumers.

To achieve the stated and other features, advantages and objects, embodiments of the present invention provide methods and systems for managing a financial account for a consumer which involves, for example, establishing a special-purpose financial account by a financial institution for a consumer relating to one or more consumer-designated future purchases for a pre-determined purchase price pre-arranged with a vendor, which can include, without limitation, the financial institution. The special-purpose financial account is earmarked for the future purchase at the pre-determined purchase price, which is pre-arranged in an agreement, for example, by the financial institution. In addition, the consumer, in effect, enters a commitment to consummate the purchase for the pre-determined purchase price.

Thereafter, contributions to a principal balance of the special-purpose financial account for embodiments of the invention are received and interest is accrued on the principal balance by the financial institution until the principal balance and accrued interest equals a consumer-designated target amount. The contributions can be received wholly or partly on a pre-designated periodic basis and wholly or partly by regular contributions on the pre-designated periodic basis. Further, the contributions can be received wholly or partly from a linked account, such as a linked checking account or savings account. Additionally, the contributions can be received at least partly, for example, from a financial institution and/or merchant and can be in the form, for example, of currency gift certificates, and/or dollar matching contributions.

In embodiments of the invention, the rate at which interest is accrued on the special-purpose financial account can be a rate that is greater than the rate of interest normally paid by the financial institution on a like principal balance in a non-special-purpose financial account. The target amount of the account can be designated by the consumer, for example, when the special-purpose financial account is established or at a later time after the account is established and can be changed by the consumer from time to time.

According to embodiments of the invention, when the principal balance and accrued interest reaches the consumer-designated target amount, the account is disposed of by the financial institution according to pre-defined parameters. For example, if the consumer directs application of the accumulated principal balance and accrued interest to the pre-determined purchase price, the accumulated principal balance and accrued interest are applied to the pre-determined purchase price. On the other hand, if the consumer declines to apply the accumulated principal balance and accrued interest to the purchase price, the accumulated principal balance is delivered to the consumer and the accrued interest is retained by the financial institution.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a table that illustrates examples of types of contributions that can be received in the special purpose financial account for an embodiment of the invention;

FIG. 2 is a table that illustrates examples of optional times at which the consumer can designate the target amount for embodiments of the invention; and

FIG. 3 is a flow chart that illustrates an example of the process of establishing and managing the special purpose financial account for an embodiment of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

An aspect of the present invention provides a method and system for managing financial accounts that involves creating a type of financial account, for example, by a financial institution, such as a bank, to which consumers can contribute money and on which the financial institution provides incentives to do so. A key feature of the particular account is that it is earmarked for use by the consumer for purchasing a particular item or a bundle of items.

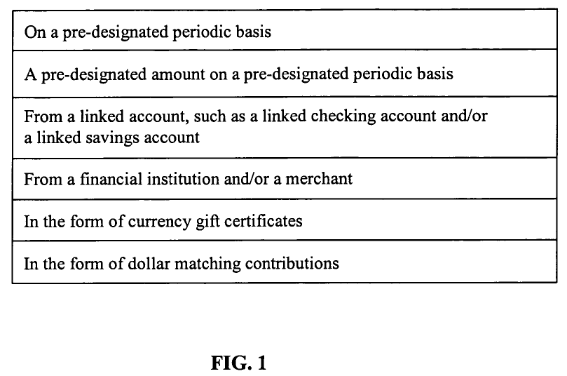

Thus, a consumer who wishes to make a large item purchase, such as a plasma screen TV, can deposit sums, such as $10, $20, or the like, in the account for an embodiment of the invention from time-to-time, albeit on a fixed time frame, and continue to contribute, for example, on a pre-designated basis. FIG. 1 is a table that illustrates examples of types of contributions that can be received in the special purpose financial account for an embodiment of the invention. As noted, a key feature of an embodiment of the invention is that all of the funds in the account are earmarked for the specific purpose of future purchases, such as for the plasma screen TV.

In the foregoing example, the consumer can wait until the full purchase price of the particular plasma screen TV accumulates in the account, including interest at a generously high rate, and purchase the TV at that time. Alternatively, at the consumer's option, after accumulating a percentage of the purchase price, such as 20%, 50%, or 80% of the purchase price, the consumer can select from among various financing opportunities offered by the financial institution to finance the balance of the purchase price.

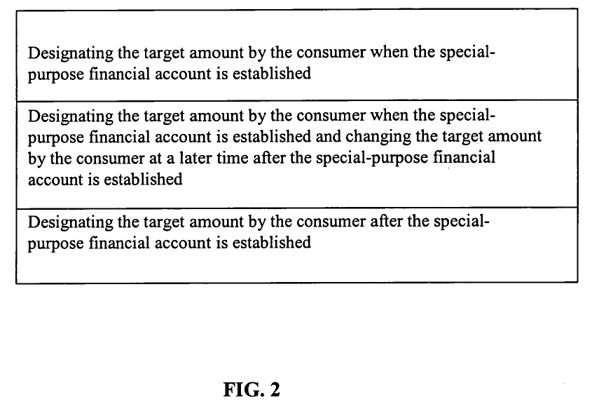

The consumer may elect the option to accumulate a percentage rather than the full amount of the purchase price from the beginning or may make the election at a later time. For example, in an embodiment of the invention, the consumer can contact the financial institution online, by telephone, or in some other way in which the consumer normally communicates with the financial institution, to inquire about the balance in the account. FIG. 2 is a table that illustrates examples of optional times at which the consumer can designate the target amount for embodiments of the invention.

If the consumer's goal is to accumulate a percentage, such as 50% of the purchase price, and that sum has accumulated in the account, the financial institution can offer the consumer various financing options, such as an installment loan, an existing financial institution credit card, or a new financial institution credit card application, or the like.

It is to be understood, that the interest rate paid by the financial institution on the account can equal to or greater than that which is normally paid on similar savings account balances. The purpose of a generous rate of interest is to create a savings mechanism for consumers to make large item purchases, and if needed, the financial institution can also offer them financing opportunities to pay a part of the purchase price. Or in addition, alternative incentives may be provided by the financial institution or the merchant to enable further savings in the account. Accordingly, in an embodiment of the invention, the financial institution can impose certain conditions on the account.

The financial institution may also offer targeted incentives or alerts to the consumer as the price of the product changes over time. If the price becomes more favorable, the consumer may have the option to purchase the item earlier with financing terms available if 100% of the price has not been met.

Thus, in an aspect of the invention, if after accumulating all or a portion of the purchase price of the large item, such as the plasma screen TV, in the account, the consumer decides not to purchase the item, the account is closed and the principal of the account is delivered to the consumer. However, all interest on the account is forfeited. In another aspect of the invention, if the consumer elects the option to purchase the particular item, such as the plasma screen TV, before the full amount of the purchase price is accumulated, and decides to pay the balance of the purchase price, for example, in cash instead of using one of the financing options offered by the financial institution, likewise, the account is closed and the principal of the account is delivered to the consumer, but the interest is forfeited.

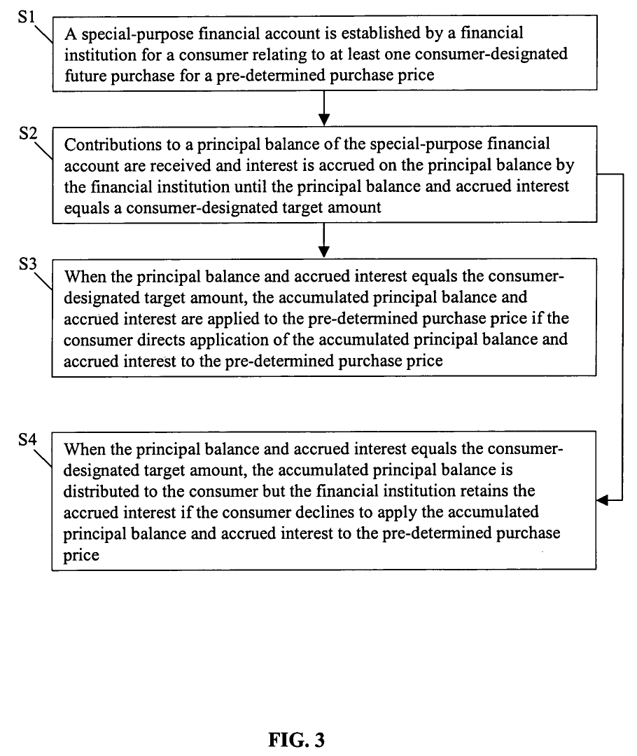

FIG. 3 is a flow chart that illustrates an example of the process of establishing and managing the special purpose financial account for an embodiment of the invention. Referring to FIG. 3, at S1, a special-purpose financial account is established by a financial institution for a consumer relating to at least one consumer-designated future purchase for a pre-determined purchase price pre-arranged by the financial institution. At S2, contributions to a principal balance of the special-purpose financial account are received and interest is accrued on the principal balance by the financial institution until the principal balance and accrued interest equals a consumer-designated target amount.

Referring further to FIG. 3, at S3, when the principal balance and accrued interest equals the consumer-designated target amount, the accumulated principal balance and accrued interest are applied to the pre-determined purchase price if the consumer directs application of the accumulated principal balance and accrued interest to the pre-determined purchase price. Alternatively, at S4, when the principal balance and accrued interest equals the consumer-designated target amount, the accumulated principal balance is distributed to the consumer but the financial institution retains the accrued interest if the consumer declines to apply the accumulated principal balance and accrued interest to the pre-determined purchase price.

In embodiments of the invention, the financial institution is in communication with and/or works with the vendor who confirms the purchase of the end item. For example, the financial institution works with a vendor, such as a major retailer that sells plasma screen TV's or a manufacturer of plasma screen TV's, and the consumer essentially commits to buy the particular plasma screen TV from the particular vendor. If the purchase is not consummated, the principal of the account is delivered to the consumer, but the interest is forfeited.

Further, inasmuch as the vendor with whom the financial institution works stocks inventory in view of the commitment on the part of the consumer to purchase the particular plasma screen TV, in an embodiment of the invention, if the consumer decides not to purchase the TV, likewise the account is closed and the principal of the account is delivered to the consumer without the interest and in addition, pre-determined fees may be imposed, such as restocking fees or account maintenance fees.

An obvious advantage to a consumer who opens the account for an embodiment of the invention and waits until the full purchase price of the particular large item accumulates in the account before buying it, rather than immediately buying the item and financing its purchase, is that instead of paying interest on the purchase price to the financial institution, the financial institution pays interest on the account to the consumer.

Embodiments of the invention and various aspects of the invention can be implemented wholly or partly utilizing computer hardware and software including, without limitation, machine-readable medium on which is encoded program code for managing the special-purpose financial account for embodiments of the invention.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method for managing a financial account for a consumer, comprising:
establishing a special-purpose financial account by a financial institution for a consumer relating to at least one consumer-designated future purchase for a pre-determined purchase price;
receiving contributions to a principal balance of the special-purpose financial account and accruing interest on the principal balance by the financial institution until the principal balance and accrued interest equals a consumer-designated target amount; and
when the principal balance and accrued interest equals the consumer-designated target amount, disposing of the account by the financial institution according to pre-defined parameters consisting at least in part of the following:
if the consumer directs application of the accumulated principal balance and accrued interest to the pre-determined purchase price, applying the accumulated principal balance and accrued interest to the pre-determined purchase price, and
if the consumer declines to apply the accumulated principal balance and accrued interest to the pre-determined purchase price, delivering the accumulated principal balance to the consumer and retaining the accrued interest by the financial institution.

2. The method of claim 1, wherein establishing the account further comprises earmarking the special-purpose financial account for the consumer-designated future purchase.

3. The method of claim 1, wherein establishing the account further comprises pre-arranging an agreement for the pre-determined purchase price with a vendor by the financial institution.

4. The method of claim 1, wherein establishing the account further comprises entering a commitment to consummate the consumer-designated future purchase for the pre-determined purchase price by the consumer.

5. The method of claim 1, wherein receiving the contributions further comprises receiving the contributions at least in part on a pre-designated periodic basis.

6. The method of claim 5, wherein receiving the contributions on the pre-designated periodic basis further comprises receiving regular contributions of a pre-designated amount on the pre-designated periodic basis.

7. The method of claim 1, wherein receiving the contributions further comprises receiving the contributions at least in part from a linked account.

8. The method of claim 7, wherein receiving the contributions from the linked account further comprises receiving the contributions at least in part from one of a linked checking account and a linked savings account.

9. The method of claim 1, wherein receiving the contributions further comprises receiving the contributions at least in part from one of a financial institution and a merchant.

10. The method of claim 1, wherein receiving the contributions further comprises receiving the contributions at least in part in the form of currency gift certificates.

11. The method of claim 1, wherein receiving the contributions further comprises receiving the contributions at least in part in the form of dollar matching contributions.

12. The method of claim 1, wherein accruing the interest further comprises accruing interest on the principal balance of the special-purpose financial account at a rate that is greater than a rate of interest paid by the financial institution on a like principal balance in a non-special-purpose financial account.

13. The method of claim 1, wherein receiving the contributions and the accruing interest until the principal balance and accrued interest equals the consumer-designated target amount further comprises receiving the consumer's designation of the target amount when the special-purpose financial account is established.

14. The method of claim 13, wherein receiving the contributions and the accruing interest until the principal balance and accrued interest equals the consumer-designated target amount further comprises receiving a change in the consumer's designation of the target amount after the special-purpose financial account is established.

15. The method of claim 1, wherein receiving the contributions and the accruing interest until the principal balance and accrued interest equals the consumer-designated target amount further comprises receiving the consumer's designation of the target amount after the special-purpose financial account is established

16. A machine-readable medium on which is encoded program code for managing a financial account, the program code comprising instructions for:
establishing a special-purpose financial account by a financial institution for a consumer relating to at least one consumer-designated future purchase for a pre-determined purchase price;
receiving contributions to a principal balance of the special-purpose financial account and accruing interest on the principal balance by the financial institution until the principal balance and accrued interest equals a consumer-designated target amount; and
when the principal balance and accrued interest equals the consumer-designated target amount, disposing of the account by the financial institution according to pre-defined parameters consisting at least in part of the following:
if the consumer directs application of the accumulated principal balance and accrued interest to the pre-determined purchase price, applying the accumulated principal balance and accrued interest to the pre-determined purchase price, and
if the consumer declines to apply the accumulated principal balance and accrued interest to the pre-determined purchase price, delivering the accumulated principal balance to the consumer and retaining the accrued interest by the financial institution.

17. A computer-implemented system for managing a financial account for a consumer, comprising:
means for establishing a special-purpose financial account by a financial institution for a consumer relating to at least one consumer-designated future purchase for a pre-determined purchase price;
means for receiving contributions to a principal balance of the special-purpose financial account and accruing interest on the principal balance by the financial institution until the principal balance and accrued interest equals a consumer-designated target amount; and
means for disposing of the account by the financial institution according to pre-defined parameters when the principal balance and accrued interest equals the consumer-designated target amount, the pre-defined parameters consisting at least in part of the following:
if the consumer directs application of the accumulated principal balance and accrued interest to the pre-determined purchase price, applying the accumulated principal balance and accrued interest to the pre-determined purchase price, and
if the consumer declines to apply the accumulated principal balance and accrued interest to the pre-determined purchase price, delivering the accumulated principal balance to the consumer and retaining the accrued interest by the financial institution.
